(19) United States
(12) Patent Application Publication
(10) Pub. No.: US 2025/0083120 A1
(43) Pub. Date: Mar. 13, 2025

(54) FEEDSTOCK REACTOR AND METHOD OF COOLING A FEEDSTOCK REACTOR

(71) Applicant: EKONA POWER INC., Burnaby (CA)

(72) Inventor: Brendan Gordon Cade, Vancouver (CA)

(21) Appl. No.: 18/827,080

(22) Filed: Sep. 6, 2024

Related U.S. Application Data
(60) Provisional application No. 63/537,958, filed on Sep. 12, 2023.

(51) Int. Cl. B01J 19/26

(52) U.S. Cl. CPC B01J 19/26; B01J 2219/00085; B01J 2219/029

(57) ABSTRACT

A feedstock reactor includes a reaction chamber for receiving a feedstock, a combustion chamber for receiving a combustible gas mixture, a passageway extending from the combustion chamber to the reaction chamber for allowing combustion products generated in the combustion chamber, by combustion of the combustible gas mixture, to flow into the reaction chamber, and a nozzle at an end of the passageway for allowing the combustion products flowing along the passageway to flow into the reaction chamber via the nozzle. The nozzle includes a nozzle wall along which the combustion products flow, and a heat-conducting portion positioned to transfer heat from the combustion products flowing through the nozzle away from the nozzle wall.

### CROSS-REFERENCE TO RELATED APPLICATION

This application claims priority from U.S. Provisional Patent Application Ser. No. 63/537,958 filed on Sep. 12, 2023, the entire disclosures of which are part of the disclosure of the present application and are hereby incorporated by reference in their entireties.

### FIELD

The present disclosure relates to thermal pyrolysis and in particular to a feedstock reactor and a method of cooling a feedstock reactor.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Such pyrolysis may be achieved, for example, by bringing the feedstock gas into thermal contact with a hot fluid. For instance, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

During operation, it is important to manage cooling of the feedstock reactor and its various components. When using combustion products to drive the pyrolysis, repeated combustion cycles will raise the temperature of the reactor, and insufficient cooling may lead to a variety of problems. For example, during the filling of the combustors, the stoichiometric premix of fuel and oxidant must be administered into an environment without risk of auto-ignition as this could otherwise lead to disastrous results such as premature detonation while valves are open. The resulting backflow into the upstream fluid systems could cause immediate shutdown and the need for repairs.

### SUMMARY

According to a first aspect of the disclosure, there is provided a feedstock reactor comprising: a reaction chamber for receiving a feedstock; a combustion chamber for receiving a combustible gas mixture; a passageway extending from the combustion chamber to the reaction chamber for allowing combustion products generated in the combustion chamber, by combustion of the combustible gas mixture, to flow into the reaction chamber; and a nozzle at an end of the passageway for allowing the combustion products flowing along the passageway to flow into the reaction chamber via the nozzle, wherein the nozzle comprises: a nozzle wall along which the combustion products flow; and a heat-conducting portion positioned to transfer heat from the combustion products flowing through the nozzle away from the nozzle wall.

The nozzle may extend into an internal volume of the reaction chamber.

The heat-conducting portion may comprise a sleeve surrounding the nozzle wall.

The heat-conducting portion may comprise copper.

The nozzle wall may comprise Inconel.

The reaction chamber may comprise a reaction chamber outer wall surrounding an internal volume of the reaction chamber. The feedstock reactor may further comprise one or more controllers configured to control a cooling system for actively cooling the reaction chamber outer wall.

The combustion chamber may comprise a combustion chamber outer wall that is joined to the reaction chamber outer wall. The cooling system may be configured to actively cool an interface at which the reaction chamber outer wall is joined to the combustion chamber outer wall.

The reaction chamber may comprise a reaction chamber outer wall surrounding an internal volume of the reaction chamber. The heat-conducting portion may be further positioned to transfer heat from the combustion products flowing through the nozzle away from the nozzle wall and to the reaction chamber outer wall.

The combustion chamber may comprise a combustion chamber outer wall that is joined to the reaction chamber outer wall. The heat-conducting portion may be further positioned to transfer heat from the combustion products flowing through the nozzle away from the nozzle wall and to the reaction chamber outer wall via the combustion chamber outer wall.

The passageway may be a first passageway. The nozzle may further comprise second passageways connecting the first passageway to an internal volume of the reaction chamber and for allowing the combustion products flowing along the first passageway to flow into the internal volume via the second passageways.

The heat-conducting portion may be in contact with the combustion chamber outer wall.

According to a further aspect of the disclosure, there is provided a method of cooling a feedstock reactor, comprising: flowing a feedstock into a reaction chamber connected to a combustion chamber; flowing a combustible gas mixture into the combustion chamber; combusting the combustible gas mixture in the combustion chamber to generate combustion products that flow into the reaction chamber via a nozzle, mix with the feedstock, and cause decomposition of the feedstock; and cooling a nozzle wall of the nozzle by using a heat-conducting portion of the nozzle to transfer heat from the combustion products flowing through the nozzle away from the nozzle wall.

This summary does not necessarily describe the entire scope of all aspects. Other aspects, features, and advantages will be apparent to those of ordinary skill in the art upon review of the following description of specific embodiments.

### BRIEF DESCRIPTION OF DRAWINGS

Embodiments of the disclosure will now be described in detail in conjunction with the accompanying drawings of which:

FIG. 1 is a schematic diagram of a feedstock reactor being operated, according to an embodiment of the disclosure;

FIG. 2 shows a nozzle for injecting combustion products into a reaction chamber of a feedstock reactor, according to an embodiment of the disclosure;

FIG. 3A shows a simulated temperature profile of a nozzle without a heat-conducting jacket; and

FIG. 3B shows a simulated temperature profile of a nozzle with a heat-conducting jacket, according to an embodiment of the disclosure.

### DETAILED DESCRIPTION

The present disclosure seeks to provide a novel feedstock reactor and a novel method of cooling a feedstock reactor. While various embodiments of the disclosure are described below, the disclosure is not limited to these embodiments, and variations of these embodiments may well fall within the scope of the disclosure which is to be limited only by the appended claims.

Generally, embodiments of the disclosure relate to methods and systems for performing pyrolysis of a feedstock gas, such as natural gas or a hydrocarbon gas, such as methane. Examples of such methods of pyrolysis, as well as example feedstock gas reactors that may be used for such pyrolysis, are described in further detail in Patent Cooperation Treaty (PCT) Publication No. WO 2020/118417, herein incorporated by reference in its entirety.

According to embodiments of the disclosure, a feedstock reactor comprises a reaction chamber for receiving a feedstock, a combustion chamber for receiving a combustible gas mixture, and a passageway extending from the combustion chamber to the reaction chamber for allowing combustion products generated in the combustion chamber, by combustion of the combustible gas mixture, to flow into the reaction chamber. The feedstock reactor further includes a nozzle at an end of the passageway for allowing the combustion products flowing along the passageway to flow into the reaction chamber via the nozzle. The nozzle includes a nozzle wall along which the combustion products flow, and a heat-conducting portion positioned to transfer heat from the combustion products flowing through the nozzle away from the nozzle wall.

The nozzle typically experiences the greatest heat stress due to high rates of forced convective heat transfer. This is a result of the flow of combustion products having high Reynolds numbers and being at sonic speeds. While the nozzle wall may be formed of a temperature-resistant material such as Inconel, even such a material may not be able to withstand the high temperatures generated as a result of the combustion of the combustible gas mixture, especially over a relatively high number of reaction cycles. In particular, Inconel has poor thermal conductivity and is difficult to cool. In addition, providing the nozzle with internal coolant passages (designed for the flow of coolant to cool the nozzle) may also not succeed since the mechanical strength of the nozzle wall may be compromised.

Therefore, according to embodiments of the disclosure, a heat-conducting portion is used to assist in transferring heat away from the nozzle wall. For example, the heat-conducting portion, which may be a heat-conducting jacket surrounding the nozzle wall and having a coefficient of thermal conductivity that is greater than that of the nozzle wall, may allow heat to be transferred away from the nozzle and toward an outer wall of the reaction chamber. An active cooling mechanism may also be used to further cool the reactor, for example by providing active cooling to the outer wall of the reaction chamber, for instance by pumping a coolant through flow passages adjacent the outer wall of the reaction chamber.

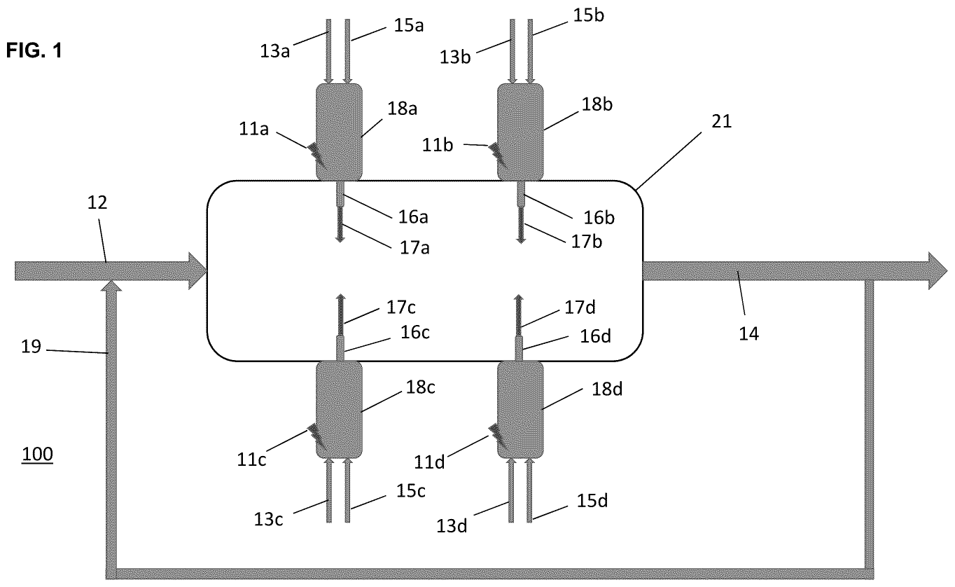

Turning to FIG. 1, there is shown schematically an embodiment of a feedstock reactor 100 used to decompose feedstock, according to an embodiment of the disclosure.

Reactor 100 includes a reaction chamber 21 connected to multiple combustors 18a-18d (which collectively may be referred to as combustors 18). Each combustor 18 includes a combustion chamber into which is fed an oxidant 13a-13d (for example, pure oxygen or air) and a fuel 15a-15d (for example, unreacted feedstock). Each combustor 18 further includes an igniter 11a-11a for triggering combustion of the fuel and the oxidant within the combustion chamber.

During a reaction cycle of reactor 100, a feedstock 12 (such as a hydrocarbon, for example methane) is fed under pressure into reaction chamber 21, and combustors 18a-18d are filled with a combustible gas mixture comprising a mixture of fuel 15a-d and oxidant 13a-d. Once reaction chamber 21 and combustors 18 have been loaded with feedstock and combustible gas mixture, respectively, igniters 11a-d are triggered and cause combustion of the combustible gas mixture in combustors 18 which results in the generation of hot combustion products 17a-d. Combustion products 17a-d flow under pressure through nozzles 16a-d that are connected to combustors 18 and that extend into the interior volume of reaction chamber 21. Combustion products 17a-d are ejected out of nozzles 16a-d and mix with the feedstock within reaction chamber 21.

As a result of the flow of combustion products 17a-d into reaction chamber 21, thermal energy is transferred from combustion products 17a-d to the feedstock. Energy is also transferred from combustion products 17a-d to the feedstock via dynamic compression of the feedstock as a result of the pressure increasing within reaction chamber 21 in response to the flow of hot, pressurized combustion products into reaction chamber 21. Past a certain point, the increase in the temperature of the feedstock is sufficient to drive decomposition or pyrolysis of the feedstock. In the case of methane, for example, the decomposition takes the following form:

CH₄+energy→C+2H₂

The pyrolysis reaction generates reaction products 14 that are extracted from reaction chamber 21. A portion of reaction products 14 is recycled back to reaction chamber 21 for future reaction cycles. Reaction products 14 may comprise one or more of hydrogen, nitrogen, and carbon. The unwanted products may comprise primarily carbon dioxide, nitrogen, and water. The recycled gas mixture may comprise primarily unreacted natural gas, hydrogen, nitrogen, and carbon monoxide.

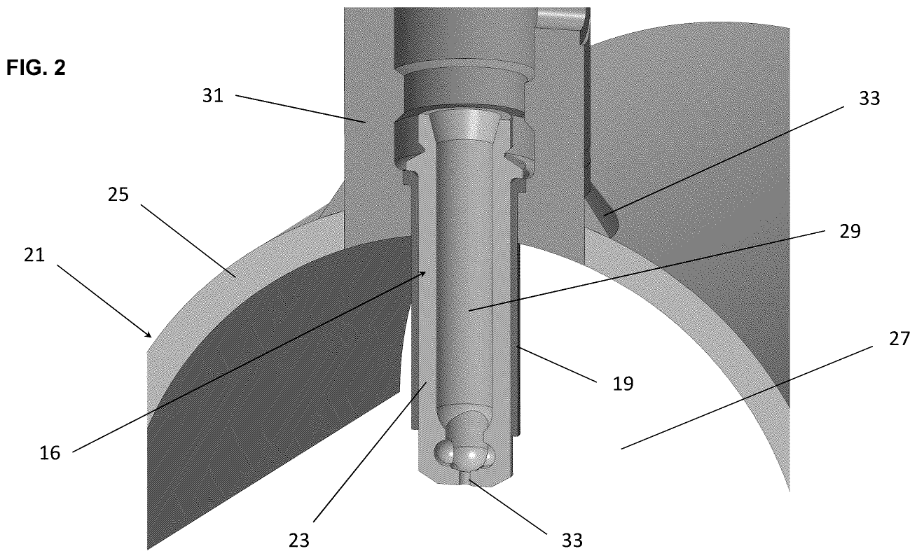

FIG. 2 shows a magnified view of a nozzle 16 extending through an outer wall or shell 25 of reaction chamber 21 and into the interior volume 27 of reaction chamber 21. Nozzle 16 includes a cylindrical nozzle wall 23 (which may be formed of Inconel) surrounding an inner passageway 29 extending longitudinally through nozzle 16 from a combustion chamber (not shown in FIG. 2) to interior volume 27 of reaction chamber 21. An outer body 31 of the combustor that houses the combustion chamber is shown in FIG. 2. Outer body 31 is inserted into a corresponding aperture formed within outer wall 25, and a weld 33 is used to seal the interface of outer body 31 and outer wall 25.

Passageway 29 is fluidly connected to interior volume 27 by multiple smaller fluid conduits 33 (one of which is shown in FIG. 2). Fluid conduits 33 are oriented and positioned such that combustion products flowing from the combustion chamber and along passageway 29 are injected into interior volume 27 along multiple different flow paths, thereby promoting improved mixing of the combustion products and the feedstock within interior volume 27.

A copper jacket or sleeve 19 is provided around nozzle wall 23, for example by press-fitting nozzle wall 23 into copper sleeve 19. Copper sleeve 19 has good thermal conductivity and therefore, as combustion products are flowing through nozzle 16 and along nozzle wall 23, copper sleeve 19 assists in transferring heat away from nozzle wall 23. In particular, heat is transferred from nozzle wall 23 toward outer shell 25 of reaction chamber 21, via outer body 31 of the combustor. As can be seen in FIG. 2, copper sleeve 19 is in contact with both nozzle wall 23 and outer body 31.

Although not shown in FIG. 2, one or more active cooling mechanisms may be used to assist in removing heat transferred to outer shell 25 from nozzle wall 23 by copper sleeve 19. For example, one or more pumps under control of one or more controllers (such as computer controllers comprising circuitry) may be used to flow a coolant through channels provided adjacent to outer shell 25. For instance, according to some embodiments, active cooling may be provided at the interface between outer shell 25 and combustor body 31, where weld 33 is shown in FIG. 2. For example, a jacket or copper tubing, compressed using straps, may be provided at the location of this interface. Coolant, such as chilled water, may then be flowed through the jacket/tubing.

Advantageously, the use of copper sleeve 19 may provide a high-efficiency thermal conduction path between nozzle wall 23 and outer shell 25. Active cooling, as described above, may then be used to remove the heat from outer shell 25. Such a design may avoid the need for cooling conduits to penetrate reaction chamber 21 which may otherwise compromise the integrity of reaction chamber 21 and impact the mechanical strength of nozzle 16.

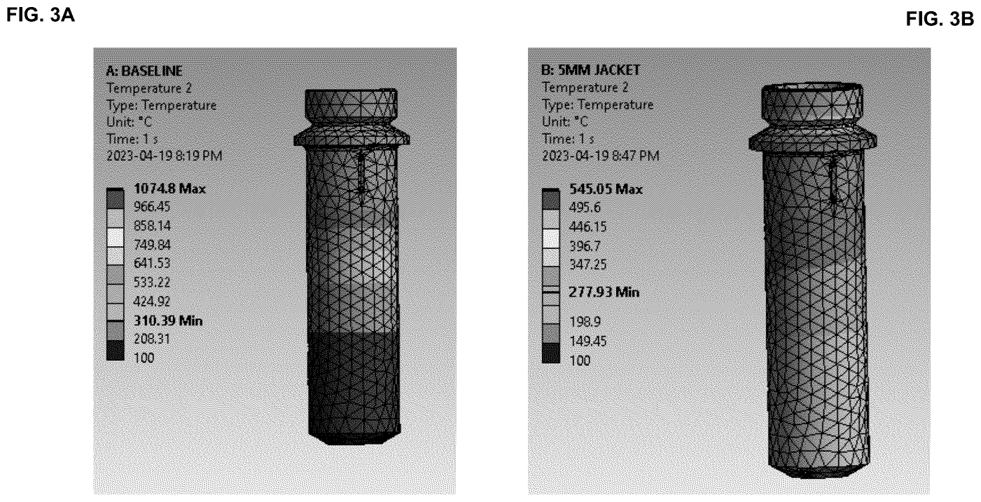

FIGS. 3A and 3B show simulated heat profiles of a nozzle without a heat-conducting sleeve or jacket (FIG. 3A) and with a heat-conducting sleeve or jacket (FIG. 3B).

Although copper is disclosed as the material used in the heat-conducting portion of the nozzle, other heat-conducting materials may be used.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A feedstock reactor comprising:
a reaction chamber for receiving a feedstock;
a combustion chamber for receiving a combustible gas mixture;
a passageway extending from the combustion chamber to the reaction chamber for allowing combustion products generated in the combustion chamber, by combustion of the combustible gas mixture, to flow into the reaction chamber; and
a nozzle at an end of the passageway for allowing the combustion products flowing along the passageway to flow into the reaction chamber via the nozzle, wherein the nozzle comprises:
a nozzle wall along which the combustion products flow; and
a heat-conducting portion positioned to transfer heat from the combustion products flowing through the nozzle away from the nozzle wall.

2. The feedstock reactor of claim 1, wherein the nozzle extends into an internal volume of the reaction chamber.

3. The feedstock reactor of claim 1, wherein the heat-conducting portion comprises a sleeve surrounding the nozzle wall.

4. The feedstock reactor of claim 1, wherein the heat-conducting portion comprises copper.

5. The feedstock reactor of claim 1, wherein the nozzle wall comprises Inconel.

6. The feedstock reactor of claim 1, wherein:
the reaction chamber comprises a reaction chamber outer wall surrounding an internal volume of the reaction chamber; and
the feedstock reactor further comprises one or more controllers configured to control a cooling system for actively cooling the reaction chamber outer wall.

7. The feedstock reactor of claim 6, wherein:
the combustion chamber comprises a combustion chamber outer wall that is joined to the reaction chamber outer wall; and
the cooling system is configured to actively cool an interface at which the reaction chamber outer wall is joined to the combustion chamber outer wall.

8. The feedstock reactor of claim 1, wherein:
the reaction chamber comprises a reaction chamber outer wall surrounding an internal volume of the reaction chamber; and
the heat-conducting portion is further positioned to transfer heat from the combustion products flowing through the nozzle away from the nozzle wall and to the reaction chamber outer wall.

9. The feedstock reactor of claim 8, wherein:
the combustion chamber comprises a combustion chamber outer wall that is joined to the reaction chamber outer wall; and
the heat-conducting portion is further positioned to transfer heat from the combustion products flowing through the nozzle away from the nozzle wall and to the reaction chamber outer wall via the combustion chamber outer wall.

10. The feedstock reactor of claim 1, wherein:
the passageway is a first passageway; and
the nozzle further comprises second passageways connecting the first passageway to an internal volume of the reaction chamber and for allowing the combustion products flowing along the first passageway to flow into the internal volume via the second passageways.

11. The feedstock reactor of claim 9, wherein the heat-conducting portion is in contact with the combustion chamber outer wall.

12. A method of cooling a feedstock reactor, comprising:
flowing a feedstock into a reaction chamber connected to a combustion chamber;
flowing a combustible gas mixture into the combustion chamber;
combusting the combustible gas mixture in the combustion chamber to generate combustion products that flow into the reaction chamber via a nozzle, mix with the feedstock, and cause decomposition of the feedstock; and
cooling a nozzle wall of the nozzle by using a heat-conducting portion of the nozzle to transfer heat from the combustion products flowing through the nozzle away from the nozzle wall.

13. The method reactor of claim 12, wherein the heat-conducting portion comprises a sleeve surrounding the nozzle wall.

14. The method of claim 12, wherein the heat-conducting portion comprises copper.

15. The method of claim 12, wherein the nozzle wall comprises Inconel.

16. The method of claim 12, further comprising actively cooling an outer wall of the reaction chamber.

17. The method of claim 16, wherein actively cooling the outer wall comprises flowing a coolant adjacent the outer wall.

18. The method of claim 16, wherein actively cooling the outer wall further comprises actively cooling an interface at which the outer wall of the reaction chamber is joined to an outer wall of the combustion chamber.

19. The method of claim 12, wherein cooling the nozzle wall comprises using the heat-conducting portion to transfer heat from the combustion products flowing through the nozzle away from the nozzle wall and to the outer wall of the reaction chamber.

20. The feedstock reactor of claim 19, wherein cooling the nozzle wall comprises using the heat-conducting portion to transfer heat from the combustion products flowing through the nozzle away from the nozzle wall and to the reaction chamber outer wall via the combustion chamber outer wall.
